(19) United States
(12) Patent Application Publication
(10) Pub. No.: US 2020/0255315 A1
(43) Pub. Date: Aug. 13, 2020

(54) GLASS TANK FURNACE AND GLASS MELTING METHOD

(71) Applicant: JUSHI GROUP CO., LTD., Tongxiang (CN)

(72) Inventors: Peijun SHEN, Tongxiang (CN); Changying FANG, Tongxiang (CN)

(73) Assignee: JUSHI GROUP CO., LTD., Tongxiang (CN)

(21) Appl. No.: 16/088,758

(22) PCT Filed: Jun. 30, 2016
(86) PCT No.: PCT/CN2016/087860

§ 371 Date: Sep. 26, 2018

(30) Foreign Application Priority Data
Jun. 22, 2016 (CN) 201610474169.X

(51) Int. Cl. C03B 5/04; C03B 5/235; C03B 5/24; F27D 19/00; F27B 3/28

(52) U.S. Cl. CPC C03B 5/04; C03B 5/2353; F27D 2019/0043; F27D 19/00; F27B 3/28; C03B 5/24

(57) ABSTRACT

A glass tank furnace and a glass melting method. The tank furnace comprises a melting portion. The melting portion comprises a melting tank. The melting tank is provided with at least one burner mounted on a crown. Each burner is provided with a gas fuel conduit for supplying gas fuel and an oxygen conduit for providing oxygen. A gas fuel flowmeter and a gas fuel control valve are provided on the gas fuel conduit. An oxygen flowmeter and an oxygen control valve are provided on the oxygen conduit. The gas fuel flowmeter, the gas fuel control valve, the oxygen flowmeter and the oxygen control valve are all connected with a control unit.

The present application claims priority to Chinese Patent Application No. 201610474169.X filed to State Intellectual Property Office on Jun. 22, 2016 and entitled “GLASS TANK FURNACE AND GLASS MELTING METHOD”, the disclosure of which is hereby incorporated by reference in its entirety.

### TECHNICAL FIELD OF THE PRESENT INVENTION

The present invention relates to the technical field of glass tank furnaces, and in particular to a glass tank furnace and a glass melting method.

### BACKGROUND OF THE PRESENT INVENTION

A glass tank furnace structure includes a batch feeder, a melting portion, a flue, a passageway, and burners and electrodes provided on the furnace. The batch feeder is disposed on a front wall or breast walls at two sides of the melting portion, the flue is disposed on the breast walls at two sides or the front wall of the melting portion, and the burners are disposed on the breast walls at two sides of the melting portion. The flame from the burners is parallel to the level of liquid glass. The electrodes for auxiliary heating are arranged on the bottom of the melting portion.

The melting of glass is to heat the glass batch in the furnace to a high temperature by the burners to obtain uniform liquid glass, the bubbles, textures and stones of which are all controlled within a certain range and conform to the molding requirements. Meanwhile, after the electrodes arranged on the bottom are powered on, the current generates joule heat through the liquid glass to auxiliary heat the liquid glass in the bottom of the furnace. The double-heated liquid glass reaches a bushing in the passageway through a throat, to be drawn and formed.

In such a glass tank furnace structure, the burners are disposed on the breast walls at two sides of the melting portion; the flame from the burners is parallel to the glass batch or the level of the liquid glass in the melting portion; and, the raw glass material or the liquid glass is mainly heated by radiative heat transfer. As a result, the heat utilization is low, and the heat of the flame radiated onto the raw glass material or the level of the liquid glass will not be utilized maximally, resulting in high energy consumption. How to improve the heat utilization and stability of the burners and the heat receiving effect of the level of liquid glass is a technical problem to be solved.

### SUMMARY OF THE PRESENT INVENTION

In order to solve the above technical problem, the present invention provides a glass tank furnace and a glass melting method.

The present invention provides a glass tank furnace, including a melting portion, wherein the melting portion includes a melting tank; at least one burner mounted on a crown is provided in the melting tank; the burner is provided with a gas fuel conduit for supplying gas fuel and an oxygen conduit for supplying oxygen; a gas fuel flowmeter and a gas fuel control valve are provided on the gas fuel conduit; an oxygen flowmeter and an oxygen control valve are provided on the oxygen conduit; and, the gas fuel flowmeter, the gas fuel control valve, the oxygen flowmeter and the oxygen control valve are all connected to a control unit;

the gas fuel flowmeter is configured to transmit the detected gas fuel flow to the control unit;

the oxygen flowmeter is configured to transmit the detected oxygen flow to the control unit;

the control unit is configured to receive the gas fuel flow from the gas fuel flowmeter, receive the oxygen flow from the oxygen flowmeter, according to the gas fuel flow and the oxygen flow, determine a control signal for the gas fuel control valve or the oxygen control valve or determine a control signal for the gas fuel control valve and a control signal for the oxygen control valve, and transmit the corresponding control signal to the gas fuel control valve or the oxygen control valve or transmit the corresponding control signal to the gas fuel control valve and the corresponding control signal to the oxygen control valve;

the gas fuel control valve is configured to receive the control signal and then perform valve control according to the control signal; and

the oxygen control valve is configured to receive the control signal and then perform valve control according to the control signal.

Wherein, the control unit is further configured to, when determining a control signal for the gas fuel control valve or the oxygen control valve or when determining a control signal for the gas fuel control valve and a control signal for the oxygen control valve, when it is determined that a ratio of the gas fuel flow to the oxygen flow is greater than a preset ratio range, determine a control signal for decreasing the valve opening of the gas fuel control valve or a control signal for increasing the valve opening of the oxygen control valve; when it is determined that the ratio of the gas fuel flow to the oxygen flow is less than the preset ratio range, determine a control signal for increasing the valve opening of the gas fuel control valve or a control signal for decreasing the valve opening of the oxygen control valve; and, when it is determined that the ratio of the gas fuel flow to the oxygen flow is within the preset ratio range, determine a control signal for maintaining the valve opening of the gas fuel control valve and a control signal for maintaining the valve opening of the oxygen control valve.

Wherein, the preset ratio range is 1:3 to 1:2.

Wherein, a gas fuel conduit and an oxygen conduit of a burner mounted at the center of the crown within the melting tank form a concentric structure; the gas fuel conduit is an inner conduit of the concentric structure, and the oxygen conduit is an outer conduit of the concentric structure; and, an included angle between a gas fuel conduit and an oxygen conduit of each of burners mounted on two sides of the crown within the melting tank is 0° to 5°.

Wherein, the melting tank is configured to be divided into the following zones along a liquid glass flow direction: a first zone used as a raw material zone, a second zone used as a foam zone and a third zone used as a clarification zone; at least one burner is disposed at a position on the crown above the first zone; at least one burner is disposed at a position on the crown above the second zone; and, at least one burner is disposed at a position on the crown above the third zone.

Wherein, the control unit is further configured to determine a gas fuel flow rate and an oxygen flow rate according to the gas fuel flow and the oxygen flow and then determine a control signal for the gas fuel control valve and a control signal for the oxygen control valve so that a difference between the gas fuel flow rate and the oxygen flow rate is less than 10% of the gas fuel flow rate or the oxygen flow rate.

Wherein, an angle between an injection direction of the burner and each of breast walls at two sides of the glass tank furnace is 0° to 14°, and an angle between the injection direction of the burner and each of a front wall and a rear wall of the glass tank furnace is 0°.

A glass melting method using the glass tank furnace described above is provided, including steps of:

providing, in a melting tank, at least one burner mounted on a crown; mounting a burner, when at the center of the crown, having a gas fuel conduit and an oxygen conduit with the gas fuel conduit and the oxygen conduit forming a concentric structure, and mounting a burner or burners, when on either of the two sides of the crown, each having a gas fuel conduit and an oxygen conduit with the gas fuel conduit and the oxygen conduit forming an included angle of 0° to 5°;

providing a gas fuel flowmeter and a gas fuel control valve on the gas fuel conduit of each burner, providing an oxygen flowmeter and an oxygen control valve on the oxygen conduit of each burner, and providing a control unit connected to all of the gas fuel flowmeter, the gas fuel control valve, the oxygen flowmeter and the oxygen control valve of each burner; and

by the control unit, receiving a gas fuel flow from the gas fuel flowmeter of the burner, receiving an oxygen flow from the oxygen flowmeter, according to the gas fuel flow and the oxygen flow, determining a control signal for the gas fuel control valve or the oxygen control valve of the burner or determining a control signal for the gas fuel control valve and a control signal for the oxygen control valve, and correspondingly controlling the gas fuel control valve and/or the oxygen control valve.

Wherein, the step of according to the gas fuel flow and the oxygen flow, determining a control signal for the gas fuel control valve or the oxygen control valve of the burner or determining a control signal for the gas fuel control valve and a control signal for the oxygen control valve and correspondingly controlling the gas fuel control valve and/or the oxygen control valve comprises: when it is determined that a ratio of the gas fuel flow to the oxygen flow is greater than a preset ratio range, performing control of decreasing the valve opening of the gas fuel control valve or performing control of increasing the valve opening of the oxygen control valve; when it is determined that the ratio of the gas fuel flow to the oxygen flow is less than the preset ratio range, performing control of increasing the valve opening of the gas fuel control valve or performing control of decreasing the valve opening of the oxygen control valve; and, when it is determined that the ratio of the gas fuel flow to the oxygen flow is within the preset ratio range, maintaining the valve opening of the gas fuel control valve and the valve opening of the oxygen control valve, and the preset ratio range is 1:3 to 1:2.

Wherein, the method further includes steps of: determining a gas fuel flow rate and an oxygen flow rate according to the gas fuel flow and the oxygen flow, and then determining a control signal for the gas fuel control valve and a control signal for the oxygen control valve so that a difference between the gas fuel flow rate and the oxygen flow rate is less than 10% of the gas fuel flow rate or the oxygen flow rate.

In the present invention, by detecting in real time and controlling a gas fuel flow and an oxygen flow of a burner, the heat output of the burner is stabilized, and the heat utilization is improved. Different composition structures of gas fuel conduits and the oxygen conduit are provided for burners in the center of and at two sides of a crown, so that the heat receiving effect of the level of liquid glass is improved.

### BRIEF DESCRIPTION OF THE DRAWINGS

The accompanying drawings incorporated into the description and constituting a part of the description show the embodiments of the present invention, and are used for explaining the principle of the present invention in combination with the description. In these accompanying drawings, similar reference numerals represent similar elements. The accompanying drawings described hereinafter are some of but not all of the embodiments of the present invention. A person of ordinary skill in the art can obtain other drawings according to these drawings without paying any creative effort.

FIG. 1 is a structural diagram of a glass tank furnace in an embodiment;

FIG. 2 is a schematic view of a connection between burners and a control unit in an embodiment; and

FIG. 3 is a flowchart of a glass melting method in an embodiment.

### DETAILED DESCRIPTION OF THE PRESENT INVENTION

To make the objectives, technical solutions and advantages of the embodiments of the present invention clearer, the technical solutions in the embodiments of the present invention will be described clearly and completely in conjunction with the drawings in the embodiments of the present invention. Apparently, the described embodiments are some of but not all of the embodiments of the present invention. All other embodiments obtained by a person of ordinary skill in the art based on the embodiments of the present invention without paying any creative effort shall fall into the protection scope of the present invention. It is to be noted that the embodiments in the present application and the features in the embodiments can be combined at will if not conflict.

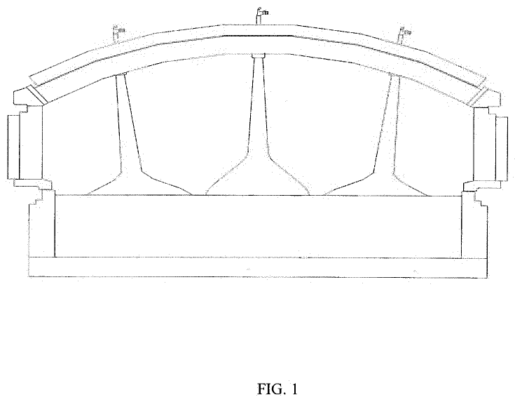

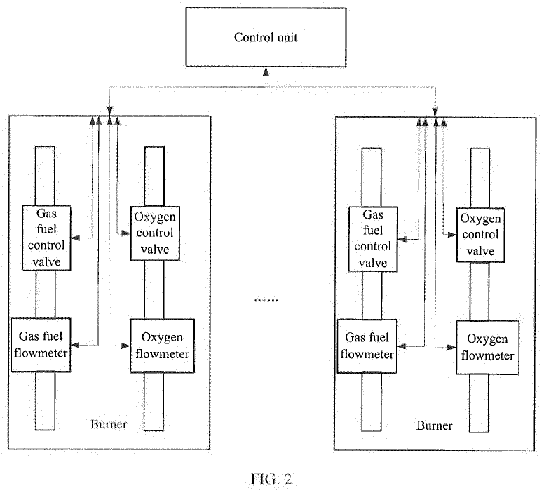

FIG. 1 is a structural diagram of a glass tank furnace in an embodiment. FIG. 2 is a schematic view of a connection between burners and a control unit in this embodiment. With references to FIGS. 1 and 2, the glass tank furnace includes a melting portion. The melting portion includes a melting tank. At least one burner mounted on a crown is provided in the melting tank. The burner is provided with a gas fuel conduit for supplying gas fuel and an oxygen conduit for supplying oxygen. A gas fuel flowmeter and a gas fuel control valve are provided on the gas fuel conduit. An oxygen flowmeter and an oxygen control valve are provided on the oxygen conduit. The gas fuel flowmeter, the gas fuel control valve, the oxygen flowmeter and the oxygen control valve are all connected to a control unit.

The gas fuel flowmeter is configured to transmit the detected gas fuel flow to the control unit.

The oxygen flowmeter is configured to transmit the detected oxygen flow to the control unit.

The control unit is configured to receive the gas fuel flow from the gas fuel flowmeter, receive the oxygen flow from the oxygen flowmeter, determine, according to the gas fuel flow and the oxygen flow, a control signal for the gas fuel control valve or the oxygen control valve or control signals for the gas fuel control valve and the oxygen control valve respectively, and transmit a corresponding control signal to the gas fuel control valve or the oxygen control valve or corresponding control signals for the gas fuel control valve and the oxygen control valve respectively.

The gas fuel control valve is configured to receive the control signal and then perform valve control according to the control signal.

The oxygen control valve is configured to receive the control signal and then perform valve control according to the control signal.

Determining, by the control unit and according to the gas fuel flow and the oxygen flow, a control signal for the gas fuel control valve or a control signal for the oxygen control valve or control signals for the gas fuel control valve and the oxygen control valve respectively includes: when it is determined that a ratio of the gas fuel flow to the oxygen flow is greater than a preset ratio range, determining a control signal for decreasing the valve opening of the gas fuel control valve or a control signal for increasing the valve opening of the oxygen control valve; when it is determined that the ratio of the gas fuel flow to the oxygen flow is less than the preset ratio range, determining a control signal for increasing the valve opening of the gas fuel control valve or a control signal for decreasing the valve opening of the oxygen control valve; and, when it is determined that the ratio of the gas fuel flow to the oxygen flow is within the preset ratio range, determining a control signal for maintaining the valve opening of the gas fuel control valve and a control signal for maintaining the valve opening of the oxygen control valve. The preset ratio range is 1:3 to 1:2, preferably 1:2.5 to 1:2.

The positions of different burners in the glass tank furnace are related to the partition of the melting tank. The melting tank is divided into the following zones along a liquid glass flow direction: a first zone used as a raw material zone, a second zone used as a foam zone and a third zone used as a clarification zone. At least one burner is disposed at a position on the crown above the first zone, at least one burner is disposed at a position on the crown above the second zone, and at least one burner is disposed at a position on the crown above the third zone.

In another embodiment, in combination with the mounting positions of the burners, gas fuel conduits and oxygen conduits of the burners at different positions in the glass tank furnace are configured in different structures. A gas fuel conduit and an oxygen conduit of a burner mounted in the center of the crown within the melting tank form a concentric structure; the gas fuel conduit is an inner conduit of the concentric structure, and the oxygen conduit is an outer conduit of the concentric structure. An included angle between a gas fuel conduit and an oxygen conduit of burners mounted on two sides of the crown within the melting tank is 0° to 5°. By this arrangement, Different composition structures of gas fuel conduits and the oxygen conduit are provided for burners at the center of and on two sides of a crown, so that the heat receiving effect of the level of liquid glass can be improved.

In another embodiment, the control unit in the glass tank furnace may also control a gas fuel flow rate and an oxygen flow rate. Specifically, the control unit is further configured to determine a gas fuel flow rate and an oxygen flow rate according to the gas fuel flow and the oxygen flow, and then determine a control signal for the gas fuel control valve and a control signal for the oxygen control valve so that a difference between the gas fuel flow rate and the oxygen flow rate is less than 10% of the gas fuel flow rate or the oxygen flow rate.

In another embodiment, an angle between an injection direction of the burner arranged in the glass tank furnace and each breast wall at two sides of the glass tank furnace is 0° to 14°, and an angle between the injection direction of the burner and each of a front wall and a rear wall of the glass tank furnace is 0°.

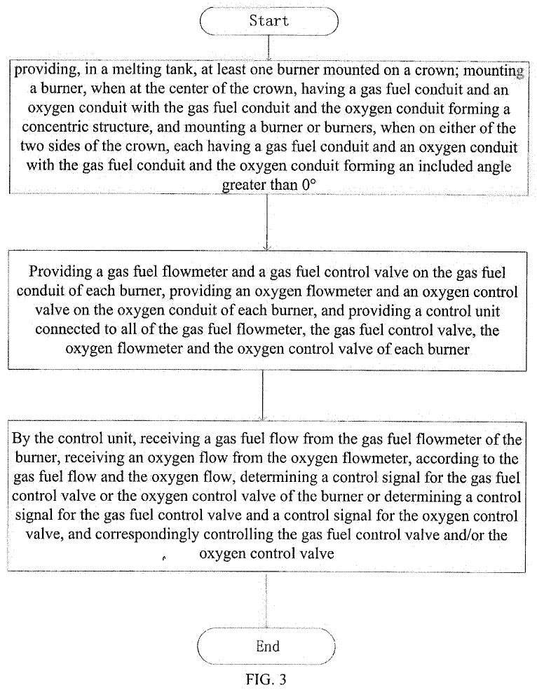

FIG. 3 is a flowchart of a glass melting method in an embodiment. A glass melting method using the glass tank furnace described above is provided, including the following steps.

Step 1: At least one burner mounted on a crown is provided within a melting tank; a burner having a gas fuel conduit and an oxygen conduit that form a concentric structure is mounted at the center of the crown; and burners each having a gas fuel conduit and an oxygen conduit that form an included angle greater than 0° are mounted on two sides of the crown.

Step 2: A gas fuel flowmeter and a gas fuel control valve are provided on the gas fuel conduit of each burner; an oxygen flowmeter and an oxygen control valve are provided on the oxygen conduit of each burner; and a control unit connected to all of the gas fuel flowmeter, the gas fuel control valve, the oxygen flowmeter and the oxygen control valve of each burner is provided.

Step 3: The control unit receives a gas fuel flow from the gas fuel flowmeter of the burner, receives an oxygen flow from the oxygen flowmeter, determines, according to the gas fuel flow and the oxygen flow, a control signal for the gas fuel control valve or the oxygen control valve of the burner or control signals for the gas fuel control valve and the oxygen control valve respectively, and correspondingly controls the gas fuel control valve and/or the oxygen control valve.

Specifically, the step 2 of determining, according to the gas fuel flow and the oxygen flow, a control signal for the gas fuel control valve or the oxygen control valve of the burner or control signals for the gas fuel control valve and the oxygen control valve respectively and correspondingly controlling the gas fuel control valve and/or the oxygen control valve includes: when it is determined that a ratio of the gas fuel flow to the oxygen flow is greater than a preset ratio range, controlling the decrease of the valve opening of the gas fuel control valve or controlling the increase of the valve opening of the oxygen control valve; when it is determined that the ratio of the gas fuel flow to the oxygen flow is less than the preset ratio range, controlling the increase of the valve opening of the gas fuel control valve or controlling the decrease of the valve opening of the oxygen control valve; and, when it is determined that the ratio of the gas fuel flow to the oxygen flow is within the preset ratio range, maintaining the valve opening of the gas fuel control valve and the valve opening of the oxygen control valve, where the preset ratio range is 1:3 to 1:2, preferably 1:2.5 to 1:2.

In order to control the burning degree of the gas fuel and oxygen, the method further includes steps of: determining a gas fuel flow rate and an oxygen flow rate according to the gas fuel flow and the oxygen flow, and then determining a control signal for the gas fuel control valve and a control signal for the oxygen control valve so that a difference between the gas fuel flow rate and the oxygen flow rate is less than 10% of the gas fuel flow rate or the oxygen flow rate.

Specific Implementation 1

On a crown of a glass tank furnace, a burner is disposed at a position above a first zone, a burner is disposed at a position above a second zone, and a burner is disposed at a position above a third zone. An angle between an injection direction of each burner and each breast wall at two sides the glass tank furnace is 12°, and an angle between the injection direction of each burner and each of a front wall and a rear wall of the glass tank furnace is 0°. A gas fuel conduit and an oxygen conduit of the burner at the center of the crown above the second zone form a concentric structure. The gas fuel conduit is an inner conduit of the concentric structure, and the oxygen conduit is an outer conduit of the concentric structure. An included angle between the gas fuel conduits of the burners on two sides of the crown and respectively above the first zone and the third zone is 3′. The control unit obtains a gas fuel flow and an oxygen flow in real time and then controls a valve of a gas fuel control valve and a valve of an oxygen control valve, so that a preset ratio range of the gas fuel flow and the oxygen flow is 1:2.4 to 1:2.2. The control unit decreases the valve opening of the gas fuel control valve or increases the valve opening of the oxygen control valve when it is determined that the ratio of the gas fuel flow to the oxygen flow is greater than the preset ratio range; and, increases the valve opening of the gas fuel control valve or decreases the valve opening of the oxygen control valve when the ratio of the gas fuel flow to the oxygen flow is less than the preset ratio range.

Specific Implementation 2

On a crown of a glass tank furnace, a burner is disposed at a position above a first zone, a burner is disposed at a position above a second zone, and a burner is disposed at a position above a third zone. An angle between an injection direction of each burner and each breast wall at two sides the glass tank furnace is 5°, and an angle between the injection direction of each burner and each of a front wall and a rear wall of the glass tank furnace is 0°. A gas fuel conduit and an oxygen conduit of the burner at the center of the crown above the second zone form a concentric structure. The gas fuel conduit is an inner conduit of the concentric structure, and the oxygen conduit is an outer conduit of the concentric structure. An included angle between the gas fuel conduits of the burners on two sides of the crown and respectively above the first zone and the third zone is 4°. The control unit obtains a gas fuel flow and an oxygen flow in real time and then controls a valve of a gas fuel control valve and a valve of an oxygen control valve, so that a preset ratio of the gas fuel flow to the oxygen flow is 1:2.4 to 1:2.3. The control unit decreases the valve opening of the gas fuel control valve or increases the valve opening of the oxygen control valve when it is determined that the ratio of the gas fuel flow to the oxygen flow is greater than the preset ratio range; and, increases the valve opening of the gas fuel control valve or decreases the valve opening of the oxygen control valve when the ratio of the gas fuel flow to the oxygen flow is less than the preset ratio range.

Specific Implementation 3

On a crown of a glass tank furnace, a burner is disposed at a position above a first zone, a burner is disposed at a position above a second zone, and a burner is disposed at a position above a third zone. An angle between an injection direction of each burner and each breast wall at two sides the glass tank furnace is 10°, and an angle between the injection direction of each burner and each of a front wall and a rear wall of the glass tank furnace is 0°. A gas fuel conduit and an oxygen conduit of the burner at the center of the crown above the second zone form a concentric structure. The gas fuel conduit is an inner conduit of the concentric structure, and the oxygen conduit is an outer conduit of the concentric structure. An included angle between the gas fuel conduits of the burners on two sides of the crown and respectively above the first zone and the third zone is 4°. The control unit obtains a gas fuel flow and an oxygen flow in real time and then controls a valve of a gas fuel control valve and a valve of an oxygen control valve, so that a preset ratio of the gas fuel flow to the oxygen flow is 1:2.25 to 1:2.1. The control unit decreases the valve opening of the gas fuel control valve or increases the valve opening of the oxygen control valve when it is determined that the ratio of the gas fuel flow to the oxygen flow is greater than the preset ratio range; and, increases the valve opening of the gas fuel control valve or decreases the valve opening of the oxygen control valve when the ratio of the gas fuel flow to the oxygen flow is less than the preset ratio range.

In the present invention, by detecting in real time and controlling a gas fuel flow and an oxygen flow of a burner, the heat output of the burner is stabilized, and the heat utilization is improved. Different composition structures of gas fuel conduits and the oxygen conduit are provided for burners at the center of and on two sides of a crown, so that the heat receiving effect of the level of liquid glass is improved.

The contents described above can be implemented independently or jointly in various ways, and these transformations shall fall into the protection scope of the present invention.

Moreover, the term “comprise/comprising”, “contain/containing” or any other variants thereof is non-exclusive, so that an object or device containing a series of elements not only contains these elements, but also contains other elements not listed clearly, or further contains inherent elements of this object or device. Without more restrictions, an element defined by the term “comprising . . . ” does not exclude other identical elements in the object or device including this element.

The foregoing embodiments are merely used for describing the technical solutions of the present invention and not intended to constitute any limitations thereto. The present invention has been described in detail with reference to the preferred embodiments. It should be understood by a person of ordinary skill in the art that modifications or equivalent replacements can be made to the technical solutions of the present invention without departing from the spirit and scope of the technical solutions of the present invention, and these modifications or equivalent replacements shall fall into the scope defined by the claims of the present invention.

### INDUSTRIAL APPLICABILITY

In the present invention, by detecting in real time and controlling a gas fuel flow and an oxygen flow of a burner, the heat output of the burner is stabilized, and the heat utilization is improved. Different composition structures of gas fuel conduits and the oxygen conduit are provided for burners at the center of and on two sides of a crown, so that the heat receiving effect of the level of liquid glass is improved.

1. A glass tank furnace, comprising a melting portion, the melting portion comprising a melting tank, at least one burner mounted on a crown is provided in the melting tank; the burner is provided with a gas fuel conduit for supplying gas fuel and an oxygen conduit for supplying oxygen; a gas fuel flowmeter and a gas fuel control valve are provided on the gas fuel conduit; an oxygen flowmeter and an oxygen control valve are provided on the oxygen conduit; and, the gas fuel flowmeter, the gas fuel control valve, the oxygen flowmeter and the oxygen control valve are all connected to a control unit;
the gas fuel flowmeter is configured to transmit the detected gas fuel flow to the control unit;
the oxygen flowmeter is configured to transmit the detected oxygen flow to the control unit;
the control unit is configured to receive the gas fuel flow from the gas fuel flowmeter, receive the oxygen flow from the oxygen flowmeter, according to the gas fuel flow and the oxygen flow, determine a control signal for the gas fuel control valve or the oxygen control valve or determine a control signal for the gas fuel control valve and a control signal for the oxygen control valve, and transmit the corresponding control signal to the gas fuel control valve or the oxygen control valve or transmit the corresponding control signal to the gas fuel control valve and the corresponding control signal to the oxygen control valve;
the gas fuel control valve is configured to receive the control signal and then perform valve control according to the control signal; and
the oxygen control valve is configured to receive the control signal and then perform valve control according to the control signal.

2. The glass tank furnace according to claim 1, wherein,
the control unit is further configured to, when determining a control signal for the gas fuel control valve or the oxygen control valve or when determining a control signal for the gas fuel control valve and a control signal for the oxygen control valve: when it is determined that a ratio of the gas fuel flow to the oxygen flow is greater than a preset ratio range, determine a control signal for decreasing the valve opening of the gas fuel control valve or a control signal for increasing the valve opening of the oxygen control valve; when it is determined that the ratio of the gas fuel flow to the oxygen flow is less than the preset ratio range, determine a control signal for increasing the valve opening of the gas fuel control valve or a control signal for decreasing the valve opening of the oxygen control valve; and, when it is determined that the ratio of the gas fuel flow to the oxygen flow is within the preset ratio range, determine a control signal for maintaining the valve opening of the gas fuel control valve and a control signal for maintaining the valve opening of the oxygen control valve.

3. The glass tank furnace according to claim 2, wherein,
the preset ratio range is 1:3 to 1:2.

4. The glass tank furnace according to claim 1, wherein,
a gas fuel conduit and an oxygen conduit of a burner mounted at the center of the crown within the melting tank form a concentric structure; the gas fuel conduit is an inner conduit of the concentric structure, and the oxygen conduit is an outer conduit of the concentric structure;
and, an included angle between a gas fuel conduit and an oxygen conduit of each of burners mounted on two sides of the crown within the melting tank is 0° to 5°.

5. The glass tank furnace according to claim 1, wherein,
the melting tank is configured to be divided into the following zones along a liquid glass flow direction: a first zone used as a raw material zone, a second zone used as a foam zone and a third zone used as a clarification zone; at least one burner is disposed at a position on the crown above the first zone; at least one burner is disposed at a position on the crown above the second zone; and, at least one burner is disposed at a position on the crown above the third zone.

6. The glass tank furnace according to claim 1, wherein,
the control unit is further configured to determine a gas fuel flow rate and an oxygen flow rate according to the gas fuel flow and the oxygen flow, and then determine a control signal for the gas fuel control valve and a control signal for the oxygen control valve so that a difference between the gas fuel flow rate and the oxygen flow rate is less than 10% of the gas fuel flow rate or the oxygen flow rate.

7. The glass tank furnace according to claim 1, wherein,
an angle between an injection direction of the burner and each of breast walls at two sides of the glass tank furnace is 0° to 14°, and an angle between the injection direction of the burner and each of a front wall and a rear wall of the glass tank furnace is 0°.

8. A glass melting method using the glass tank surface according to claim 1, comprising steps of:
providing, in a melting tank, at least one burner mounted on a crown; mounting a burner, when at the center of the crown, having a gas fuel conduit and an oxygen conduit with the gas fuel conduit and the oxygen conduit forming a concentric structure, and mounting a burner or burners, when on either of the two sides of the crown, each having a gas fuel conduit and an oxygen conduit with the gas fuel conduit and the oxygen conduit forming an included angle of 0° to 5°;
providing a gas fuel flowmeter and a gas fuel control valve on the gas fuel conduit of each burner, providing an oxygen flowmeter and an oxygen control valve on the oxygen conduit of each burner, and providing a control unit connected to all of the gas fuel flowmeter, the gas fuel control valve, the oxygen flowmeter and the oxygen control valve of each burner; and
by the control unit, receiving a gas fuel flow from the gas fuel flowmeter of the burner, receiving an oxygen flow from the oxygen flowmeter, according to the gas fuel flow and the oxygen flow, determining a control signal for the gas fuel control valve or the oxygen control valve of the burner or determining a control signal for the gas fuel control valve and a control signal for the oxygen control valve, and correspondingly controlling the gas fuel control valve and/or the oxygen control valve.

9. The glass melting method according to claim 8, wherein,
the step of, according to the gas fuel flow and the oxygen flow, determining a control signal for the gas fuel control valve or the oxygen control valve of the burner or determining a control signal for the gas fuel control valve and a control signal for the oxygen control valve and correspondingly controlling the gas fuel control valve and/or the oxygen control valve comprises: when it is determined that a ratio of the gas fuel flow to the oxygen flow is greater than a preset ratio range, performing control of decreasing the valve opening of the gas fuel control valve or performing control of increasing the valve opening of the oxygen control valve; when it is determined that the ratio of the gas fuel flow to the oxygen flow is less than the preset ratio range, performing control of increasing the valve opening of the gas fuel control valve or performing control of decreasing the valve opening of the oxygen control valve; and, when it is determined that the ratio of the gas fuel flow to the oxygen flow is within the preset ratio range, maintaining the valve opening of the gas fuel control valve and the valve opening of the oxygen control valve, and the preset ratio range is 1:3 to 1:2.

10. The glass melting method according to claim 8, wherein,
the method further comprises steps of: determining a gas fuel flow rate and an oxygen flow rate according to the gas fuel flow and the oxygen flow, and then determining a control signal for the gas fuel control valve and a control signal for the oxygen control valve so that a difference between the gas fuel flow rate and the oxygen flow rate is less than 10% of the gas
